(19) United States
(12) Patent Application Publication
(10) Pub. No.: US 2012/0074634 A1
(43) Pub. Date: Mar. 29, 2012

(54) FIXING MECHANISM

(75) Inventors: HUI-CHENG LI, Shenzhen City (CN); HUA-CHUN XIAO, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/102,296

(22) Filed: May 6, 2011

(30) Foreign Application Priority Data
Sep. 29, 2010 (CN) 201010296648.X

(51) Int. Cl. B25B 11/00; F16F 1/00

(52) U.S. Cl. 269/287; 267/150

(57) ABSTRACT

A fixing mechanism includes a first fixing plate, a second fixing plate corresponding to the first fixing plate, and a screw connecting the first fixing plate and the second fixing plate. The first fixing plate defines a receiving hole comprising a connecting portion. The second fixing plate defines a locking hole corresponding to the connecting portion. The screw comprises a threaded shank matching with the connecting portion and the locking hole. The fixing mechanism further comprises an elastic member positioned in the receiving hole, the threaded shank abuts against the corresponding elastic member, and an elastic resistance of the elastic member limits back and forth movement of the screw.

### BACKGROUND

1. Technical Field

The present disclosure relates generally to fixing mechanisms, and particularly, to a fixing mechanism for use when driving screws using a screwdriver.

2. Description of Related Art

Most workpieces must be fixed in place during mechanical processing. A typical fixing mechanism includes a first fixing plate and a second fixing plate. The second fixing plate is connected to the first fixing plate by screws, and a workpiece is fixed between the first fixing plate and the second fixing plate. To assemble and disassemble the fixing mechanism, a worker will manually position each screw and drive them in using an electric screwdriver. This procedure ties up both hands of the worker, which is inefficient.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of a fixing mechanism.

FIG. 2 an exploded, isometric view of the fixing mechanism of FIG. 1.

FIG. 3 is a partial, enlarged, cross-section of the fixing mechanism of FIG. 1, taken along the line III-III.

FIG. 4 is an enlarged, isometric view of an elastic member of the fixing mechanism of FIG. 1.

### DETAILED DESCRIPTION

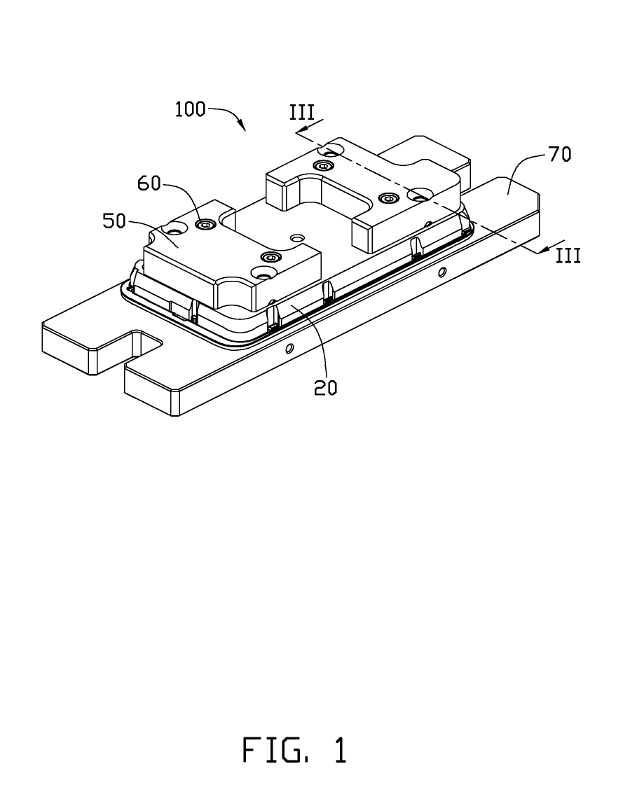

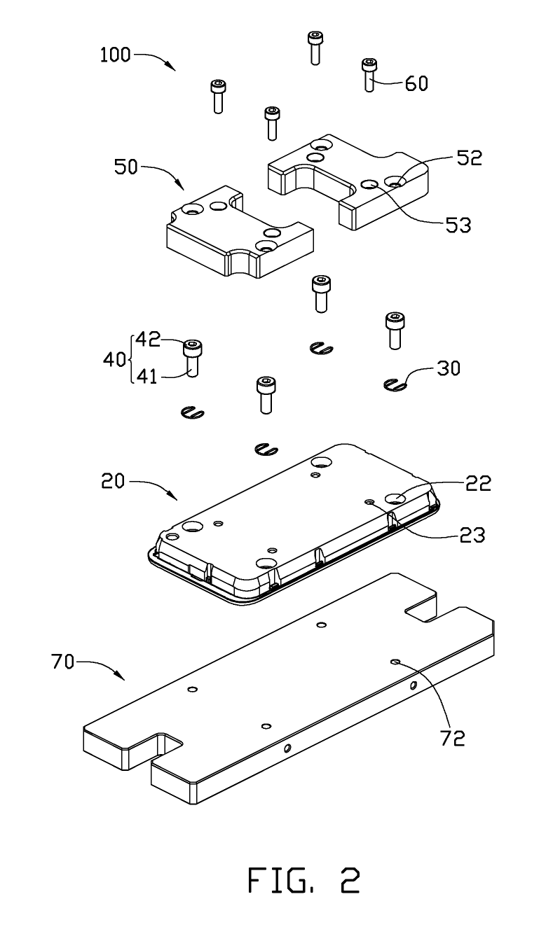

Referring to FIGS. 1 and 2, one embodiment of a fixing mechanism 100 includes a first fixing plate 20, four elastic members 30, four screws 40, two restricting blocks 50, four connecters 60, and a second fixing plate 70. The four elastic members 30 are positioned in four corners of the first fixing plate 20. The four screws 40 are connected to the corresponding elastic members 30. The two restricting blocks 50 are connected to two ends of one side of the first fixing plate 20. The four connecters 60 fix the blocks 50 to the first fixing plate 20. A workpiece (not shown) is fixed between the first fixing plate 20 and the second fixing plate 70.

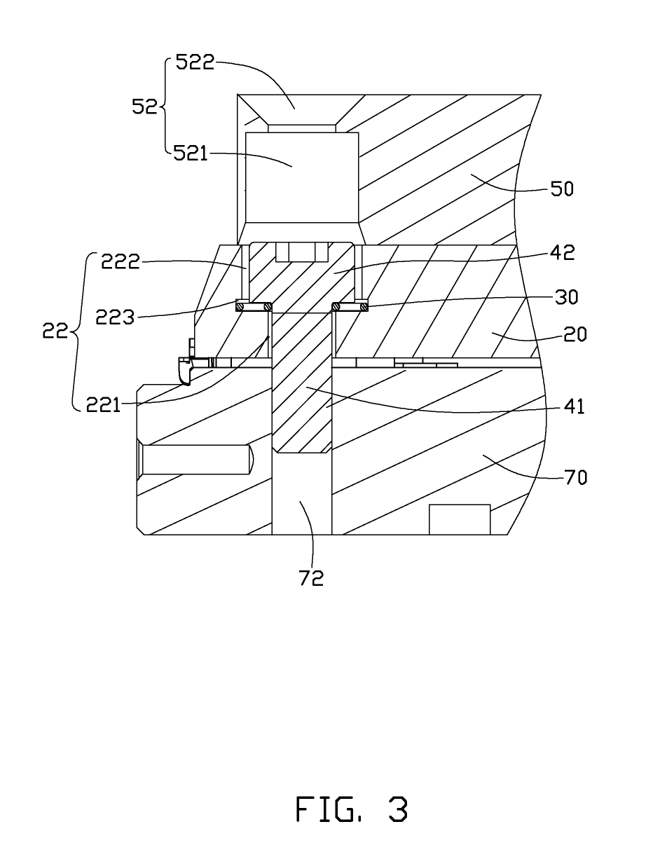

Referring to FIG. 3, the first fixing plate 20 is substantially rectangular and defines four receiving holes 22 and four fixing holes 23. The four receiving holes 22 are located adjacent to four corners of the first fixing plate 20, respectively. Each fixing hole 23 is adjacent to a receiving hole 22. Each receiving hole 22 is stepped, and includes a connecting portion 221, a receiving portion 222, and a holding portion 223 between the connecting portion 221 and the receiving portion 222. The connecting portion 221 can be substantially cylindrical and internally threaded. The receiving portion 222 is substantially cylindrical, and its diameter is larger than that of the connecting portion 221. The holding portion 223 is substantially cylindrical, and its diameter is larger than that of the receiving portion 222.

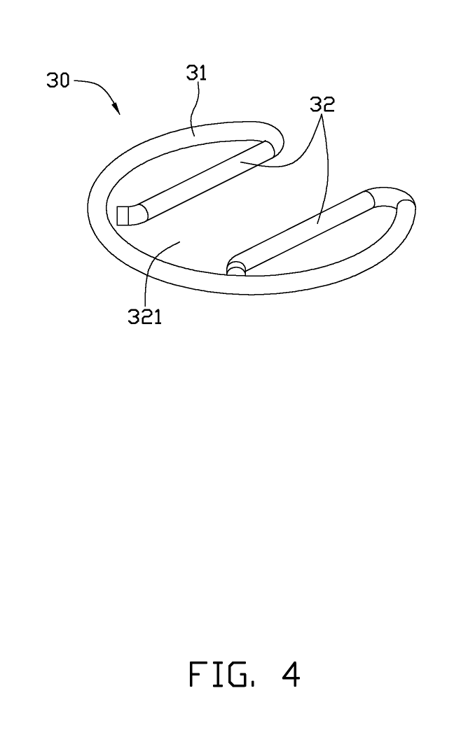

Referring to FIGS. 2 and 4, in the illustrated embodiment, the elastic members 30 are clamp springs. Each elastic member 30 includes a main portion 31 and two bent portions 32. The main portion 31 is substantially C-shaped, and the two bent portions 32 are bent from two ends of the main portion 31, and extend into an inner side of the main portion 31. The two bent portions 32 are substantially parallel, and cooperatively define an opening 321. Each elastic member 30 is positioned in the holding portion 223 of the first fixing plate 20. Referring to FIG. 3 again, the elastic member 30 is mounted in the holding portion 223 and the main portion 31 abuts against an inner wall of the holding portion 223, and the opening 321 is located in the holding portion 223 correspondingly.

Referring to FIG. 2 again, each screw 40 includes a threaded shank 41 and a head 42 extending from an end of the threaded shank 41. A diameter of the threaded shank 41 is larger than a distance of the two bent portions 32. The screws 40 are screwed into the receiving holes 22. In use, the shanks 41 abut against the corresponding bent portions 32 (see FIG. 3), and elastic resistance of the portions 32 limit back and forth movement of the screws 40.

Referring to FIG. 3 again, the restricting blocks 50 restrict up and down movement of the screws 40. Each restricting block 50 defines two resisting holes 52 corresponding to the receiving holes 22 of the first fixing plate 20, and two fastening holes 53 corresponding to the fixing holes 23 of the first fixing plate 20. Each resisting hole 52 includes a guiding portion 521 and a resisting portion 522 connected to the guiding portion 521. The guiding portion 521 is substantially cylindrical, and its diameter is larger than that of the head 42 of the screw 40. The resisting portion 522 is substantially conical, narrowing toward the guiding portion 521, and its smallest diameter is smaller than a diameter of the head 42.

The restricting blocks 50 and the first fixing plate 20 are firmly connected via the connecters 60 extending through the fastening holes 53 and the fixing holes 23. The guiding portions 521 are adjacent to the first fixing plate 20. In the illustrated embodiment, the connecters 60 are screws. It should be appreciated that the connecters 60 may be some other type of connecter, such as a latch.

The screws 40 can moved up and down in the guiding portion 521, because a diameter of the guiding portion 521 is larger than that of the head 42. The screws 40 can be blocked by the resisting portion 522, because the smallest diameter of the resisting portion 522 is smaller than the diameter of the head 42. Thus, it is conventional for a tool, such as an electric screwdriver, to drive in or extract the screws 40 via the resisting portion 522 due to the shape of the resisting portion 522. It should be appreciated that the resisting portion 522 may be other shapes, for example, polyhedral conical.

The second fixing plate 70 is substantially rectangular, and defines four locking holes 72 corresponding to the four receiving holes 22. Threads (not shown) are formed on an inner wall of the locking holes 72, for contacting with the threaded shanks 41 of the screws 40. The first fixing plate 20 and the second fixing plate 70 are firmly connected via the screws 40 extending through the receiving holes 22 and the locking holes 72.

In the fixing mechanism 100, the screws 40 are resisted by the elastic members 30 positioned in the holding portion 223 of the first fixing plate 20, for limiting up and down movement of the screws 40. The resisting portion 522 of the restricting hole 52 limit up and down movement of the screws 40. Therefore, to assemble and disassemble the fixing mechanism 100, the screws 40 are driven by a tool, such as an electrical screwdriver, and the screws 40 are moveable in a certain area without the need of manual support for a greater efficiency.

It should be appreciated that the receiving holes 22, the fixing holes 23 and the screws 40 are not limited to four, and can be any number. The number of the resisting holes 52, the locking holes 72 and the fixing holes 23 are also not limited to four.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A fixing mechanism, comprising:
a first fixing plate;
a second fixing plate corresponding to the first fixing plate; and
a screw connecting the first fixing plate and the second fixing plate, wherein the first fixing plate defines a receiving hole comprising a connecting portion; the second fixing plate defines a locking hole corresponding to the connecting portion; the screw comprises a threaded shank matching with the connecting portion and the locking hole; the fixing mechanism further comprises an elastic member positioned in the receiving hole, and the threaded shank abuts against the corresponding elastic member, an elastic resistance of the elastic member limits back and forth movement of the screw.

2. The fixing mechanism of claim 1, wherein the receiving hole further comprises a receiving portion and a holding portion between the receiving portion and the connecting portion, and the elastic member is positioned in the holding portion.

3. The fixing mechanism of claim 2, wherein the elastic member comprises a curved main portion and two bent portions bent from two ends of the main portion and extend into an inner side of the main portion, the main portion elastically abuts against an inner wall of the holding portion of the first fixing plate, and the threaded shank abuts against the bent portions.

4. The fixing mechanism of claim 1, wherein the fixing mechanism further comprises a restricting block connected to the first fixing plate, and the restricting block and the second fixing plate are positioned on opposite sides of the first fixing plate, and the restricting block restricts up and down movement of the screw.

5. The fixing mechanism of claim 4, wherein the restricting block defines a resisting hole, and the resisting hole comprises a guiding portion and a resisting portion connected to the guiding portion, and the resisting portion restricts up and down movement of the screw.

6. The fixing mechanism of claim 5, wherein the resisting portion is substantially conical, and narrows toward the guiding portion.

7. An elastic member for limiting back and forth movement of a screw, comprising:
a curved main portion;
two bent portions bent from two ends of the main portion and extend into an inner side of the main portion, and the screw comprises a threaded shank abutting against the bend portions.

8. The elastic member of claim 7, wherein the two bent portions are substantially parallel, and a distance of the two bent portions is smaller than a diameter of the threaded shank.

9. The elastic member of claim 7, wherein the elastic member is a clamp spring.
